(19) United States
(12) Patent Application Publication
(10) Pub. No.: US 2018/0104711 A1
(43) Pub. Date: Apr. 19, 2018

(54) CREAM-TYPE COSMETIC CONTAINER COMPRISING VACUUM PUMP

(71) Applicant: YONWOO CO., LTD., Incheon (KR)

(72) Inventor: Sung-Hwan Kim, Incheon (KR)

(21) Appl. No.: 15/567,831

(22) PCT Filed: Apr. 15, 2016
(86) PCT No.: PCT/KR2016/003935

§ 371 Date: Oct. 19, 2017

(30) Foreign Application Priority Data
Apr. 24, 2015 (KR) 10-2015-0058090

(51) Int. Cl. B05B 11/00; A45D 40/00; B65D 47/20

(52) U.S. Cl. CPC B05B 11/0048; A45D 40/00; A45D 2200/054; B05B 11/3042; B65D 47/20

(57) ABSTRACT

A cream-type cosmetic container comprising a vacuum pump includes a vacuum pump wherein a pumping member performs a pumping operation to discharge contents when a button cap is rotated by a predetermined section, such that contents having high viscosity can be discharged even with a small force. A discharged amount of contents can be controlled according to a rotation angle of the button cap, therefore making it possible for user to control the discharged amount of contents as much as needed.

### BACKGROUND

The present disclosure relates to a cream-type cosmetic container comprising a vacuum pump, more particularly a cream-type cosmetic container comprising a vacuum pump wherein a pumping member performs a pumping operation to discharge contents when a button cap is rotated to a predetermined section, such that contents having high viscosity can be discharged even with a small force, and also a discharged amount of contents can be controlled according to a rotation angle of the button cap, therefore making it possible for user to control the discharged amount of contents as much as needed.

Generally, a vacuum cosmetic container is configured in a way that contents contained in a cosmetic container are prevented from being contacted with air. The container comprises a container body wherein contents are stored, a support body which is coupled encasing an upper portion of the container body and supports a pumping member, a pumping member which makes an interior portion of the container body vacuumed and discharges contents according to a pumping operation, and a button part which is disposed at an upper portion of the pumping member and pressurizes the pumping member according to user's pressurizing, wherein a content discharge hole is formed at a center thereof.

A vacuum cosmetic container having structures as the above is configured such that a dent gradually sunken more toward a center thereof is equipped at an upper portion of a button part and a user can apply contents discharged on the dent with his/her hand. Since a content discharge hole is disposed at a center of the button part, a user cannot pump by pressurizing the center of the button part when using the container; instead, the user pressurizes either side of the button part which has a discharge hole in the center or both sides thereof so as to perform a pumping operation.

However, when a user pressurizes either side of the button part with one hand, the button part is likely to incline to a side and thereby cannot be pumped properly, which makes it difficult to steadily discharge a constant amount of contents.

Accordingly, a user has to pressurize both sides of the button part with a discharge hole at the center and pumps to discharge contents. In this case, the user must use both hands, which causes user inconvenience.

To solve these problems as the above, “A cream-type cosmetic container having a vacuum pump” is disclosed in Korean Publicized Patent No. 10-2013-0107388 (Hereafter, it will be referred as ‘the publicized patent’) to users.

The publicized patent above comprises an outer container; an inner container coupled to an interior of the outer container and containing contents therein, comprising a piston which ascends according to usage of content inside the inner container and at a lower end an air inflow hole such that air can flow in so as to lift the piston; a support body coupled encasing an upper portion of the outer container and supports a pumping member; a pumping member coupled to the support body and discharging content by pumping operation; a button part disposed at an upper portion of the pumping member and pressurizing the pumping member, wherein a pressurization display part is formed such that a user's hand can be safely reached to pressurize the pumping member, and a discharging part having a content discharge hole at a slanted position from the pressurization display part is formed; and a content movement part comprising a coupling tube coupled to an upper portion of the pumping member, and a communicating part which is coupled to the button part, protruding in a upward direction from the coupling tube and connected with the content movement tube, further comprising a passage where the moving direction of contents moving in a perpendicular direction through the coupling tube is changed to the content discharge hole slanted to one side, and the contents move thereunto,

It is characterized to comprise at least one or more air-moving holes formed with a portion of the upper end cut open at an upper end of the outer container such that air can move to an air inflow hole formed at a lower end of the inner container and allow a piston to ascend.

However, the publicized patent above has a configuration wherein contents are discharged through pressurizing a button part. Therefore, discharging a high viscosity content requires considerably a lot of force and in addition, it is impossible for a user to discharge as much amount of contents as he/she desires since a constant amount of contents is always discharged when the button part is pressurized. In case more amount of contents than required is discharged, it will cause an unnecessary consumption of contents.

### SUMMARY OF THE DISCLOSURE

The presently described embodiments disclosed herein relate to a cream-type cosmetic container comprising a vacuum pump, and its objectives are to provide a cream-type cosmetic container comprising a vacuum pump which is configured in that a pumping member performs a pumping operation to discharge contents when a button cap is rotated to a predetermined section, such that contents having high viscosity can be discharged even with a small force, and also a discharged amount of contents can be controlled according to a rotation angle of the button cap, therefore making it possible for user to control the discharged amount of contents as much as needed.

To solve the problems above, a cream-type cosmetic container having a vacuum pump, according to embodiments of the present disclosure, is characterized in including: an container body containing contents and having a volume thereof get smaller as contents are being used; a support body coupled as encasing an upper portion of the container body and comprising a cylinder for pumping operation of a pumping member possible; a pumping member inserted to a cylinder of the support body and discharging contents by means of pumping operation according to ascending/descending movement thereof; a button cap disposed at an upper portion of the pumping member and comprising a contents discharge hole at one side of an upper end thereof, and configured to be rotated by user's manipulation; and a pumping guide part coupled to an inner side of the button cap and rotated along with the rotation of the button cap, and transferring pressure to the pumping member in a process of rotation and thereby inducing a pumping operation of the pumping member, wherein the amount of contents being discharged is controlled by the rotation angle of the button cap.

Furthermore, the container is characterized to further include a fixation body coupled to an upper portion of the container body and provided with a display part to indicate the discharged amount of contents according to the rotation angle of the container body.

Furthermore, the container is characterized in that at least one or more pressurization protrusions extends from a bottom surface of the pumping guide part to a downward direction and pressurizes the pumping member according to the rotation of the pumping guide part.

Furthermore, the container is characterized in that at an upper end of the pumping member is equipped a pumping guide protrusion which is pressurized by the pressurization protrusion according to the rotation of the pumping guide part, wherein the pumping guide protrusion comprises a gentle slope from one side to the other side and at a dead end of the pumping guide protrusion is equipped a limiting protrusion which limits the movement of the pressurization protrusion.

Furthermore, the container is characterized in that, when a pumping guide part is rotated according to rotation of the button cap while the pressurization protrusion moves along the upper surface of the pumping guide protrusion, a stroke distance of the pumping member is adjusted by a difference of the slope heights of the pumping guide protrusion according to the rotation angle of the button cap, and thereby the discharged amount of contents is controlled.

Furthermore, the container is characterized in that a protrusion is provided at an inner circumferential surface of the fixation body such that a user can sense the rotation angle when the button cap is rotated, and a rotation protrusion which goes over the protrusion is provided at an outer circumferential surface of the button cap.

As described in the above, according to the present disclosure, a cream-type cosmetic container comprising a vacuum pump has an advantage in that a pumping member performs a pumping operation to discharge contents when a button cap is rotated by a predetermined section, such that contents having high viscosity can be discharged even with a small force, and also a discharged amount of contents can be controlled according to a rotation angle of the button cap, therefore making it possible for user to control the discharged amount of contents as much as needed.

### BRIEF DESCRIPTION OF THE DRAWINGS

FIG. 1 is an exploded perspective view illustrating a configuration of a cream-type cosmetic container comprising a vacuum pump according to an exemplary embodiment.

FIG. 2 is a combined perspective view illustrating a configuration of a cream-type cosmetic container comprising a vacuum pump according to an exemplary embodiment.

FIG. 3 is a cross-sectional view illustrating a configuration of a cream-type cosmetic container comprising a vacuum pump according to an exemplary embodiment.

FIG. 4 is an explanatory view illustrating a state wherein a rotation protrusion goes over protrusions of a cream-type cosmetic container comprising a vacuum pump when a button cap is rotated according to an exemplary embodiment.

FIGS. 5 to 8, 9A, and 9B are explanatory views illustrating using methods of a cream-type cosmetic container comprising a vacuum pump according to an exemplary embodiment.

### DETAILED DESCRIPTION

Hereinafter, embodiments will be described in detail with reference to the accompanying drawings. The same reference numerals provided in the drawings indicate the same members.

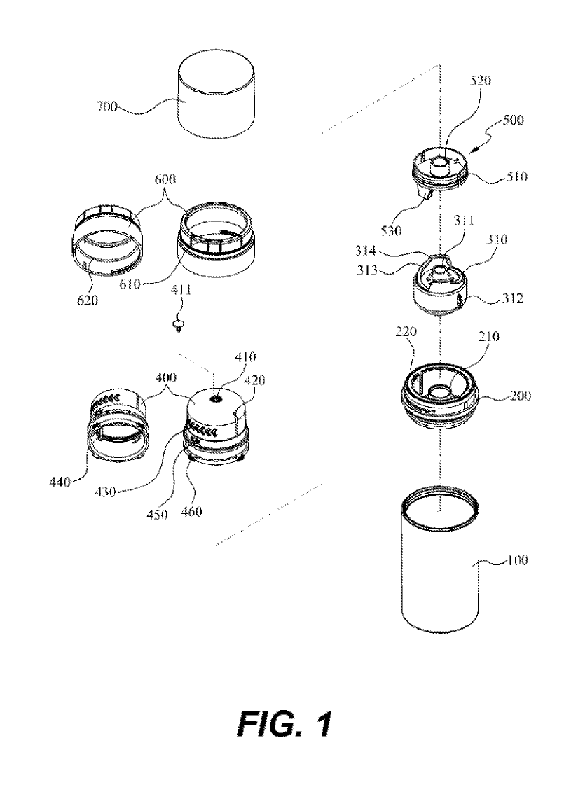

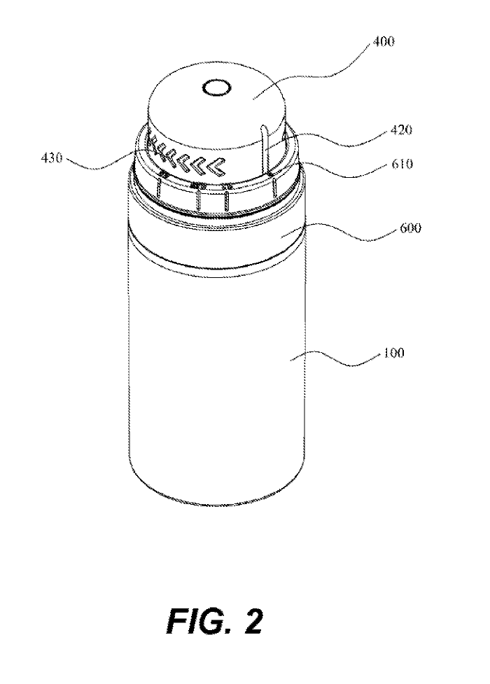

FIG. 1 is an exploded perspective view illustrating a configuration of a cream-type cosmetic container comprising a vacuum pump according to an exemplary embodiment. FIG. 2 is an assembled perspective view illustrating a configuration of cream-type cosmetic container comprising a vacuum pump according to an exemplary embodiment.

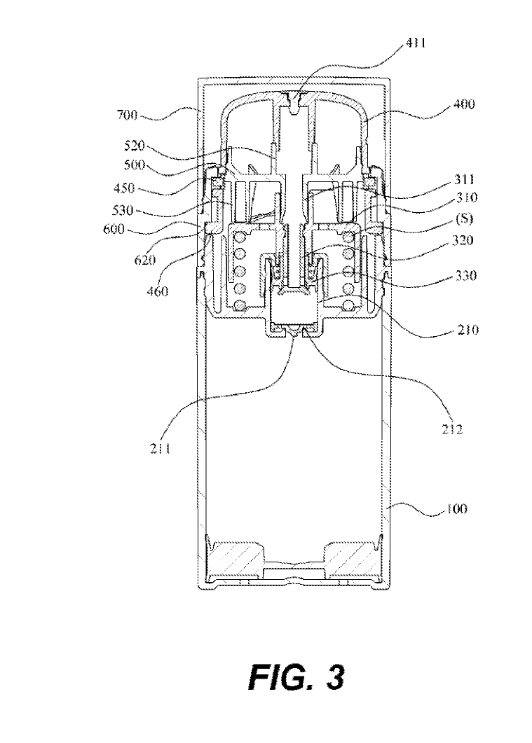

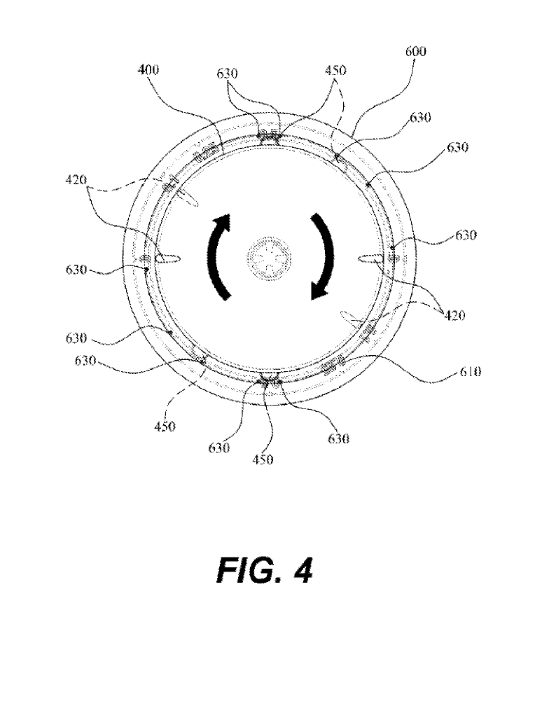

FIG. 3 is a cross-sectional view illustrating a configuration of a cream-type cosmetic container comprising a vacuum pump according to an exemplary embodiment. FIG. 4 is an explanatory view illustrating a state wherein a rotation protrusion goes over protrusions of a cream-type cosmetic container comprising a vacuum pump when a button cap is rotated according to an exemplary embodiment.

Referring to FIGS. 1 to 4, of a cream-type cosmetic container comprising a vacuum pump according to an exemplary embodiment includes a container body 100, a support body 200, a pumping member 300, a button cap 400, a pumping guide part 500, and a fixation body 600.

The container body 100, where contents are stored, is provided with a piston which ascends according to the contents being used. The container body 100 can be made of soft material which can be compressed as the contents are being used and thus its volume is getting decreased as the contents are being used.

The support body 200, encasing an upper portion of the container body 100 to be coupled, is provided with a cylinder 210 such that a piston rod 320 and a seal cap 330 of the pumping member 300 ascends/descends at a center portion thereof and makes pumping operation possible, wherein a contents inflow hole 211 is provided at a lower end of the cylinder 210 such that contents stored in the container body 100 can flow in when the pumping member 300 is operated, and a check valve 212 which opens/closes the contents inflow hole 211 according to operation of the pumping member 300 is installed at an inner side of the cylinder 210.

Furthermore, at the support body 200 is provided a perpendicular guide groove 220 such that a perpendicular guide protrusion 312 formed at an outer circumferential surface of the pumping member 300 can be inserted and ascended/descended, wherein the perpendicular guide groove 220 guides a perpendicular movement of a pump body 310 so as not to be slanted to one side when a pumping member 300 ascends/descends.

The pumping member 300 is inserted into a cylinder 210 of the support body 200 and discharges contents by a pumping operation according to an ascent/descent movement, further including a pump body 310, a piston rod 320 and a seal cap 330.

The pump body 310 is movably coupled to a contents movement tube 520 of the pumping guide part 500 and is ascended/descended according to the presence or absence of pressurization of a pressurization protrusion 530, further comprising a coupling tube 311 at a center thereof so as to be coupled with the contents movement tube 520.

The presently described embodiments are characterized in that at an upper end of the pump body 310 is equipped a pumping guide protrusion 313 which is pressurized by a pressurization protrusion 530 according to the pumping guide part 500, wherein the pumping guide protrusion 313 is configured to form a gentle slope surface from one side to the other side. Due to this, the pumping guide part 500 rotates along with a rotation of the button cap 400 and thereby a stroke distance of the pumping member 300 according to the height of the slope surface is controlled while the pressurization protrusion 530 moves along an upper surface of the pumping guide protrusion 313, such that contents can be discharged as the discharged amount of contents is being controlled.

Meanwhile, at an upper end of the pumping guide protrusion 313 is provided a limiting protrusion 314 which limits the movement of pressurization protrusions 530 so as to control the rotation angle of a pumping guide part 500.

The pump body 310, when an inner upper side thereof is supported by a spring (S) and a user applies a pressurizing force that controls the handle part 400, is moved to an upper portion by an elastic force of a spring (S), wherein in the process of upward movement move, a pressurization protrusion 530 moves to the opposite direction along the slope of the pumping guide protrusion 313 and is restored to a state for a next pumping operation.

Meanwhile, at an outer circumferential surface of the pump body 310 is provided a perpendicular guide protrusion 312 which ascends/descends along the perpendicular guide grooves 220 so as not to be inclined to one side when a pump body 310 ascends/descends.

The piston rod 320 is coupled to an inner side of the pump body 310 and moves along the movement of the pump body 310, wherein at an outer circumferential surface thereof is coupled a seal cap 330 which is tightly contacted to an inner wall of the cylinder 210 and moves according to an ascent/descent of the piston rod 320, thereby changing the inner pressure of the cylinder 210.

The button cap 400, disposed at an upper portion of the pumping member 300, and forms a contents discharge hole 410 at a center portion of the upper end thereof, prevents contents from being discharged from the discharge hole 410 when a user does not intend to and is coupled with a rubber tip 411 which is opened by pressure of contents when the contents ascends according to pumping operation of the pumping member 300.

The button cap 400, which is configured to be rotated by a user's control, rotates along with a pumping guide part 500 which is coupled at an inner side thereof when the button cap 400 rotates, wherein the pumping member 300 performs pumping operation and contents are discharged through the contents discharge hole 410 according to pressurization of the pumping member 300.

The presently described embodiments are characterized in that at an outer circumferential surface of the button cap 400 is provided a discharge amount control part 420 that is guided by a display part 610 of the fixation body 600 and controls the discharged amount of contents. When the discharge amount control part 420 is positioned on one point of a display part 610 therein, a pressurization protrusion 530 moves along an upper surface of a pumping guide protrusion 313 as much as the button cap 400 rotates. This time, a stoke distance of the pumping member 300 is controlled according to the height of a slope surface of the pumping guide protrusion 313, and thereby the discharged amount of contents can be controlled, wherein the bigger a rotation angle of the button cap 400 is, the more the contents are discharged. The discharge amount control part 420 may have a protuberance shape which protrudes from an outer circumferential surface of the button cap 400 or a groove shape which is depressed from an outer circumferential surface of the button cap 400.

At both sides of an outer circumferential surface of the button cap 400 is equipped a sliding prevention protrusion 430 for preventing a hand from sliding when controlling the rotation of the button cap 400, wherein the sliding prevention protrusion 430 is preferably configured to display a rotation direction of the button cap 400.

Meanwhile, at an inner circumferential surface of the button cap 400 is equipped a coupling protrusion 440 which is coupled with a coupling groove 510 of the pumping guide part 500 for rotating along with the pumping guide part 500 according to the rotation of the button cap 400.

Furthermore, at an outer circumferential surface of the button cap 400, as illustrated on FIG. 4, is provided a rotation protrusion 450 which goes over a protrusion 630 of the fixation body 600 in a process of rotation of the button cap 400, wherein the rotation protrusion 450 is configured to go over a multitude of protrusion 630 every time the rotation protrusion 450 passes any one display part 610 among a multitude of the display parts 610 while the button cap 400 is rotating, such that a user is able to sense with a hand the process according to the rotation angle when the button cap 400 rotates.

Meanwhile, at a rotation discharging part 400 is provided a separation prevention protrusion 460 which is supported by a fixation protrusion 620 of the fixation body 600 to be described later such that a rotation discharging part 400 can be prevented from moving to an upward direction.

The pumping guide part 500, which is coupled to an inner side of the button cap 400 and rotates along with a rotation of the button cap 400, and then transfers the pressure to the pumping member 300 while rotating for inducing a pumping operation of the pumping member 300, is provided with a coupling groove 510 that is coupled to a coupling protrusion 440 of the button cap 400.

The presently described embodiments are characterized in that at a bottom surface of the pumping guide part 500 is equipped a multitude of a pressurization protrusion 530 which extends in a downward direction and pressurizes a pumping guide protrusion 313 of the pumping member 300 according to a rotation of the button cap 400. A stoke distance of the pumping member 300 is controlled by the difference of the heights of a slope surface of the pumping guide protrusion 313 according to the rotation angle of the button cap 400 in a process that the pressurization protrusion 530 moves along an upper surface of the pumping guide protrusion 313, such that the discharged amount of contents can be controlled.

It is preferred that a lower end of the pressurization protrusion 530 should be formed of a shape that corresponds to the slope so as not to be interfered while the pressurization protrusion 530 is moving along the slope of the pumping guide protrusion 313.

Meanwhile, at a center part of the pumping guide part 500 is equipped a contents movements tube 520 such that contents moving to an upper portion there through a pumping operation of the pumping member 300 can move to a contents discharge hole 410, wherein a lower portion of the contents movement tube 520 is coupled to a coupling tube 311 of the pumping member 300 and an upper portion of the contents movement tube 520 is coupled to a lower side of the button cap 400 and forms a discharge hole 410 where contents can move from the coupling tube 311.

The fixation body 600 is coupled to an upper portion of the container body 100 and supports the button cap 400, wherein at an inner side thereof is provided a fixation protrusion 620 which supports a separation prevention protrusion 460 of the button cap 400 and limits an upward movement of the button cap 400.

The presently described embodiments are characterized in that at the fixation body 600 is provided a display part 610 which displays the discharged amount of contents according to the rotation angle of the button cap 400 which rotates the pumping guide part 500, wherein a multitude of the display part 610 are formed with a predetermined distance apart. When a user rotates the button cap 400 and and then releases a rotation pressurizing force after stopping rotating the button cap 400 at any display part 610 among a multitude of display parts 610, as much contents as the display part displays at a position where the rotation of the button part 400 is stopped are discharged.

That is, a user can control the rotation angle of the button cap 400 while checking the display part 610 when rotating the button cap 400, and thereby can discharge as much amount of contents as needed.

Meanwhile, the fixation body 600 is provided with a multitude of protrusion 630 with a predetermined distance apart along an inner circumferential surface of the fixation body 600 for a user to sense them according to the rotation angle when the button cap 400 rotates.

The over cap 700, which is detatchably coupled at an upper portion of the container body as encasing the button cap 400 at the container body 100, prevents malfunction such as the rotation of the button cap 400.

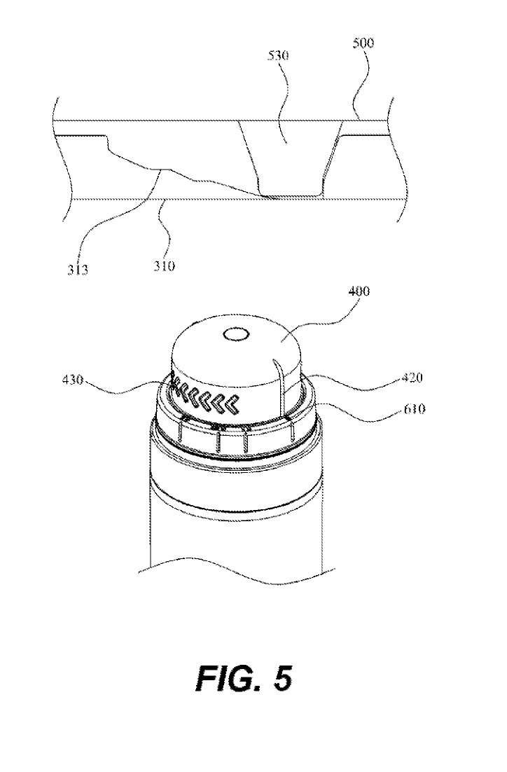

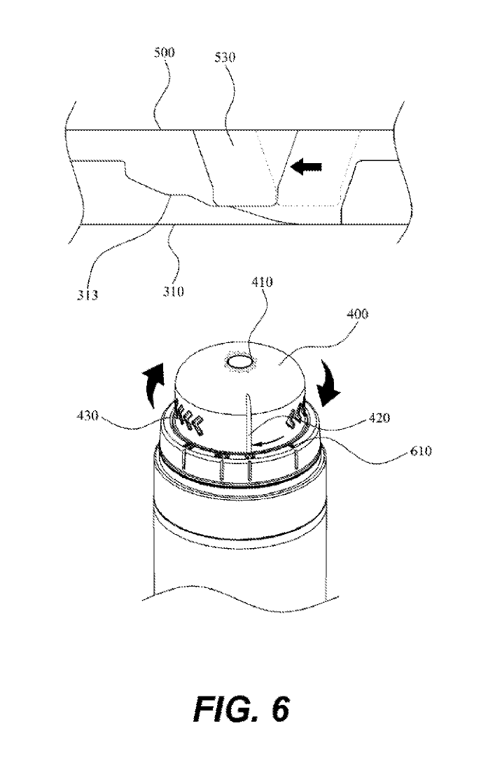

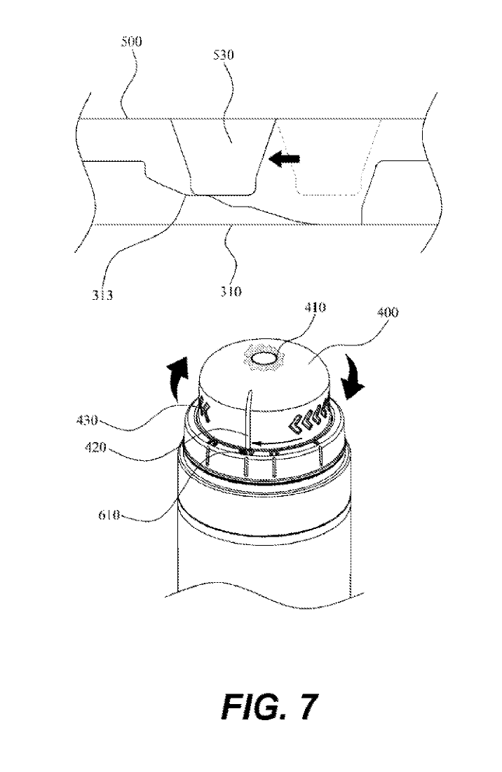

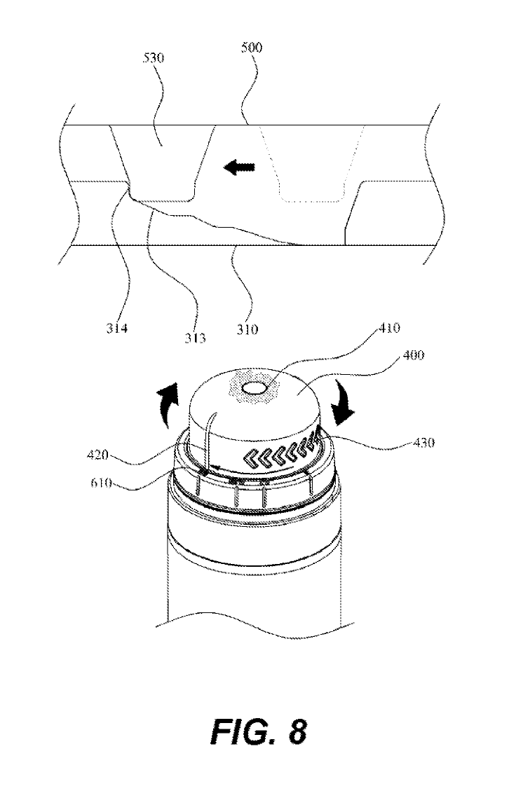

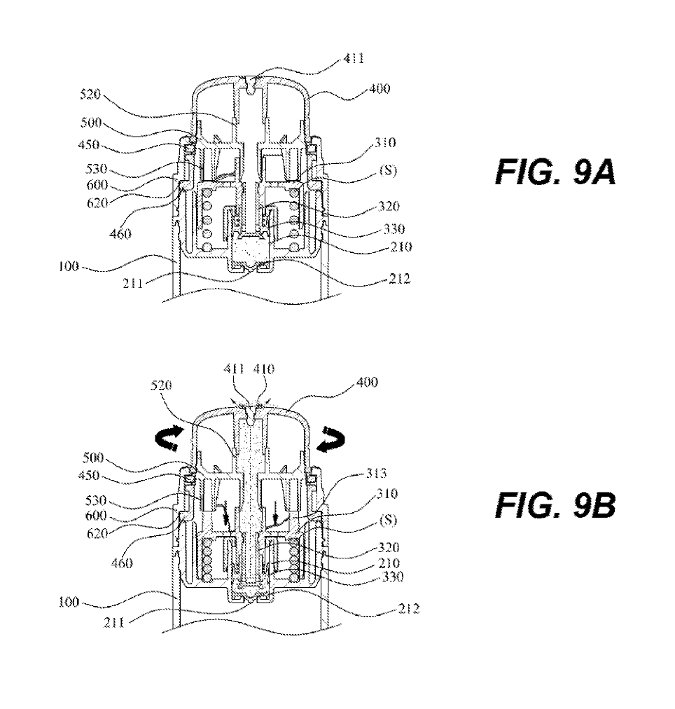

Hereinafter, referring FIGS. 4 to 8, 9A, and 9B, an operational state of a cream-type cosmetic container according to an exemplary embodiment will be described. FIGS. 5 to 8, 9A, and 9B are explanatory views illustrating how to use a cream-type cosmetic container comprising a vacuum pump according to an exemplary embodiment.

Referring FIGS. 4 to 8, 9A and 9B, a pressurization protrusion 530 is positioned at an upper end of the pump body 310 in at state that the button cap 400 is not operated. In this state, when a user rotates the button cap 400 to one side, the pressurization protrusion 530 moves along a slope surface of the pumping guide protrusion 313 as the pumping guide part 500 interlocked with the button cap 400 rotates.

As the above, when a pressurization protrusion 530 moves along a slope surface of a pumping guide protrusion 313, the pumping guide protrusion 313 is pressurized by the pressurization protrusion 530, such that a pump body 310 descends, allowing contents to be discharged by means of a pumping operation of the pumping member 300. When a user releases a rotation pressurizing force after stopping the button cap 400 at any display part 610 among a multitude of display parts 610 while rotating the handle part 400, the position of the pressurization protrusion 530 is determined at a slope surface of a pumping guide protrusion 313 according to the rotation angle of the button cap 400 and the stroke distance of the pumping member 300 is adjusted as much as the height of the slope surface of the pumping guide protrusion 313 on which the pressurization protrusion 530 is located, such that the discharged amount of contents is determined. At this time, the bigger the rotation angle of the button cap 400 is, the more the contents are discharged.

Meanwhile, when a user releases a pressurizing force that controls the button cap 400, the pump body 310 moves to an upper portion by an elastic force of a spring (S), and while moving to an upper portion thereof, a pressurization protrusion 530 moves to the opposite direction along the slope surface of the pumping guide protrusion 313 and is restored to a state for next pumping operation.

As described above, optimal embodiments have been disclosed in the drawings and the specification. Although specific terms have been used herein, these are only intended to describe the present embodiments and are not intended to limit the meanings of the terms or to restrict the scope of the accompanying claims. Therefore, those skilled in the art will appreciate that various modifications and other equivalent embodiments are possible from the above embodiments. Accordingly, the scope of the present claims should be defined by the technical spirit of disclosure in its entirety.

1. A cream-type cosmetic container comprising a vacuum pump, comprising:
a container body containing contents and having a volume thereof get smaller as contents are being used;
a support body coupled as encasing an upper portion of the container body and comprising a cylinder for pumping operation of a pumping member possible;
a pumping member inserted to the cylinder of the support body and discharging contents by means of pumping operation according to ascending/descending movement thereof;
a button cap disposed at an upper portion of the pumping member and comprising a contents discharge hole at one side of an upper end thereof, and configured to be rotated by user's manipulation; and
a pumping guide part coupled to an inner side of the button cap and rotated along with the rotation of the button cap, and transferring pressure to the pumping member in a process of rotation and thereby inducing a pumping operation of the pumping member,
wherein the amount of contents being discharged is controlled by the rotation angle of the button cap.

2. The cream-type cosmetic container comprising a vacuum pump of claim 1,
further comprising a fixation body coupled to an upper portion of the container body and provided with a display part to indicate the discharged amount of contents according to the rotation angle of the container body.

3. The cream-type cosmetic container comprising a vacuum pump of claim 2,
wherein at least one or more pressurization protrusions extend from a bottom surface of the pumping guide part to a downward direction and pressurizes the pumping member according to the rotation of the pumping guide part.

4. The cream-type cosmetic container comprising a vacuum pump of claim 3,
wherein at an upper end of the pumping member is equipped a pumping guide protrusion which is pressurized by the pressurization protrusion according to the rotation of the pumping guide part, wherein the pumping guide protrusion comprises a gentle slope surface from one side to the other side and at a dead end of the pumping guide protrusion is equipped a limiting protrusion which limits the movement of the pressurization protrusion.

5. The cream-type cosmetic container comprising a vacuum pump of claim 4,
wherein when a pumping guide part is rotated according to rotation of the button cap while the pressurization protrusion moves along the upper surface of the pumping guide protrusion, a stroke distance of the pumping member is adjusted by a difference of the slope heights of the pumping guide protrusion according to the rotation angle of the button cap, and thereby the discharged amount of contents is controlled.

6. The cream-type cosmetic container comprising a vacuum pump of claim 5,
wherein a protrusion is provided at an inner circumferential surface of the fixation body such that a user can sense the rotation angle when the button cap is rotated, and a rotation protrusion going over the protrusion is provided at an outer circumferential surface of the button cap.
